(19) United States
(12) Patent Application Publication
(10) Pub. No.: US 2026/0002800 A1
(43) Pub. Date: Jan. 1, 2026

(54) SYSTEMS AND METHODS FOR OPERATING AN OVERHEAD ELECTRICAL LINE

(71) Applicant: CTC Global Corporation, Irvine, CA (US)

(72) Inventors: Kevin Corbalis, Tustin, CA (US); Eric Bosze, San Diego, CA (US); David Goekjian, Anaheim, CA (US)

(21) Appl. No.: 19/130,218

(22) PCT Filed: Nov. 17, 2023
(86) PCT No.: PCT/US2023/080396

§ 371 Date: May 15, 2025

Related U.S. Application Data
(60) Provisional application No. 63/426,254, filed on Nov. 17, 2022.

(51) Int. Cl. G01D 5/353; G01K 11/3206; G01K 15/00; G01L 1/24; G01L 5/04; H02G 1/02

(52) U.S. Cl. CPC G01D 5/35358; G01D 5/35374; G01K 11/3206; G01K 15/005; G01L 1/246; G01L 5/04; H02G 1/02

(57) ABSTRACT

Methods and systems for the operation of an overhead electrical line. The systems include one or more distributed sensors associated with an overhead electrical cable and one or more non-distributed sensors associated with the overhead electrical cable. The non-distributed sensors may be used to corroborate line condition values obtained from the distributed sensors, or may be used to calibrate the values obtained from the non-distributed sensors.

### FIELD

This disclosure relates to the field of overhead electrical lines, and particularly to systems and methods for the operation of overhead electrical lines.

### BACKGROUND

Electrical lines, e.g., overhead transmission lines and overhead distribution lines, transport electricity from point to point within an electrical grid. For example, high voltage transmission lines are used to transport electricity from a power plant to a substation, where a transformer reduces the electrical voltage so that the electricity may then be safely delivered to end users, e.g., using sub-transmission or distribution lines that transport electricity at a lower voltage than the transmission lines.

Operators of electrical grids including overhead transmission lines and distribution lines desire to operate the electrical grid as efficiently as possible, e.g., by reducing line losses and operating the electrical grid to minimize possible damage to the electrical lines, e.g., due to over heating, which may also lead to the electrical lines sagging to an unsafe degree. It has been suggested that distributed sensors associated with the electrical lines may be utilized to determine the temperature and/or stress state of the lines so that the operator may change the voltage and/or routing of electricity within the grid. While offering many benefits, these distributed sensors may at times need to be calibrated and adjusted to provide accurate data to the line operator.

### SUMMARY

The present invention is directed to methods and systems that enable the calibration and/or corroboration of distributed sensors in an electrical line using non-distributed sensors.

In one embodiment, a method for the operation of an overhead electrical line that is operatively strung onto support towers is disclosed. The overhead electrical line comprises a first overhead electrical cable comprising a strength member and an electrical conductor surrounding the strength member. The method may include the steps of: obtaining first distributed condition data at a first time from a first distributed sensing element that extends along a length of the first overhead electrical cable, the first distributed condition data comprising at least one of first distributed cable temperature data and first distributed cable strain data; obtaining first location data associated with the first distributed condition data, the first location data identifying a first linear segment of the first distributed sensing element, wherein the steps of obtaining the first distributed condition data and obtaining the first location data comprise interrogating the first distributed sensing element using an interrogation device that is operatively attached to the first distributed sensing element; determining a first distributed condition value from the first distributed condition data; obtaining first non-distributed condition data from a first non-distributed sensor that is located proximate to the first linear segment of the first distributed sensing element, the first non-distributed condition data comprising data selected from the group consisting of first non-distributed cable temperature data and first non-distributed cable strain data; determining a non-distributed condition value from at least the first non-distributed condition data; and adjusting the interrogation device to reduce a difference between the first distributed condition value and the first non-distributed condition value.

The foregoing embodiment is subject to a number of refinements and characterizations. In one characterization, the strength member is a fiber-reinforced composite strength member. The fiber-reinforced strength member may comprise reinforcing fibers in a polymer matrix. The fiber-reinforced strength member may comprise reinforcing fibers in a thermoplastic matrix. The fiber-reinforced strength member may comprise reinforcing fibers in a thermoset matrix. The fiber-reinforced strength member may comprise reinforcing fibers in a metal matrix. The strength member may comprise a single composite strength element, or the strength member may comprise a plurality of composite strength elements.

The first distributed sensing element may extend along substantially the entire length of the overhead electrical cable. The first distributed sensing element may comprise a first optical fiber. The first optical fiber may be attached to a surface of the strength member. The first optical fiber may be embedded in the strength member. The first optical fiber may be a glass optical fiber.

The overhead electrical cable may have a length of at least about 100 meters. The overhead electrical cable may have a length of at least about 500 meters. The first linear segment may have a length of not greater than about 10 meters.

In one characterization, the first distributed condition data may include first cable temperature data and wherein the first distributed condition value is a temperature value. The first non-distributed sensor may be a thermocouple. The method may include the step of applying heat to a portion of the first overhead electrical cable that includes the first non-distributed sensor during the steps of obtaining the first distributed condition data and the first non-distributed condition data from the portion of the first overhead electrical cable. The step of adjusting the interrogation device may be performed when the difference between the first distributed condition value and the first non-distributed condition value is greater than a predetermined acceptable deviation value. The predetermined acceptance deviation value may be not greater than about 10° C. absolute.

In another characterization, the first distributed condition data may include first cable strain data, wherein the first distributed condition value is a strain value. The first non-distributed sensor may be a strain gauge. The strain gauge may be operatively affixed to the strength member. The first non-distributed sensor may be a Fiber Bragg Grating (“FBG”). The overhead electrical line may comprise a dead-end assembly securing the first overhead electrical cable to a support tower, and the first non-distributed sensor may be disposed within the dead end assembly. In another characterization, the first non-distributed sensor may include a load cell affixed to the first overhead electrical cable. The step of adjusting the interrogation device may performed when the difference between the first distributed condition value and the first non-distributed condition value is greater than a predetermined acceptable deviation value. The predetermined acceptance deviation value may be a strain value of not greater than about 0.001% absolute.

The interrogation device may comprise an OTDR device that is operatively connected to the first optical fiber. The OTDR device may be a BOTDR device. The step of adjusting the interrogation device may comprise changing at least a first calibration coefficient of the OTDR device. The first non-distributed sensor may be operatively attached to the overhead electrical cable to obtain the first non-distributed condition data directly from the electrical cable. The first non-distributed sensor may be located within the first linear segment.

The method may also include the step of obtaining second non-distributed condition data from a second non-distributed sensor that is located proximate the first linear segment of the first distributed sensing element, where the second non-distributed condition data includes data selected from the group consisting of second non-distributed cable temperature data and second non-distributed strain data. The non-distributed condition value may be obtained from the first non-distributed condition data and the second non-distributed condition data. The method may also include the step of obtaining third non-distributed condition data from a third non-distributed sensor, where the third non-distributed condition data includes data selected from the group consisting of third non-distributed cable temperature data and third non-distributed strain data.

In another embodiment, a system for the operation of an overhead electrical line is disclosed. The system may comprise: an overhead electrical line that is operatively strung onto support towers, the overhead electrical line comprising a first overhead electrical cable comprising a strength member and an electrical conductor surrounding the strength member; a first distributed sensing element that extends along a length of the first overhead electrical cable, the first distributed sensing element comprising an optical fiber; an interrogation device operatively attached to the optical fiber; and at least a first non-distributed sensor that is located proximate the first overhead electrical cable. The first non-distributed sensor may be selected from the group consisting of a temperature sensor and a strain sensor, and the first non-distributed sensor may be configured to measure at least one of a temperature value or a strain value of the overhead electrical cable.

The foregoing embodiment of a system for the operation of an overhead electrical line may be subject to a number of characterizations and refinements. In one characterization, the strength member is a fiber-reinforced composite strength member. The fiber-reinforced strength member may comprise reinforcing fibers in a polymer matrix. The fiber-reinforced strength member may comprise reinforcing fibers in a thermoplastic matrix. The fiber-reinforced strength member may comprise reinforcing fibers in a thermoset matrix. The fiber-reinforced strength member may comprise reinforcing fibers in a metal matrix. The strength member may comprise a single composite strength element, or the strength member may comprise a plurality of composite strength elements.

The first distributed sensing element may extend along substantially the entire length of the overhead electrical cable. The first distributed sensing element may comprise a first optical fiber. The first optical fiber may be attached to a surface of the strength member. The first optical fiber may be embedded in the strength member. The first optical fiber may be a glass optical fiber.

The overhead electrical cable may have a length of at least about 100 meters. The overhead electrical cable may have a length of at least about 500 meters. The first linear segment may have a length of not greater than about 10 meters.

The first non-distributed sensor may comprise a thermocouple. The first non-distributed sensor comprises an infrared camera. The first non-distributed sensor may comprise a strain gauge that is operatively coupled to the strength member. The overhead electrical line may comprise a dead-end assembly securing the first overhead electrical cable to a support tower wherein the strain gauge is disposed within the dead end assembly. The interrogation device may comprise an OTDR device that is operatively attached to the optical fiber, such as a BOTDR device.

### DESCRIPTION OF THE DRAWINGS

FIG. 1 illustrates a portion of an overhead electrical line.

FIG. 2 illustrates a cross-sectional view of an assembled dead-end termination apparatus.

FIG. 3 illustrates a perspective view of an assembled and crimped dead-end termination apparatus.

FIG. 4 illustrates a cross-sectional view of a splice that is useful for connecting two electrical cable segments.

FIGS. 5A and 5B illustrate perspective views of overhead electrical cables including fiber-reinforced composite strength members.

FIGS. 6A and 6B illustrate cross-sectional views of fiber-reinforced composite strength members incorporating optical fibers embedded within the fiber-reinforced composite material.

FIG. 7 illustrates a perspective view of an overhead electrical cable incorporating an optical fiber on a surface of the strength member.

FIG. 8 illustrates a perspective view of a portion of a transmission line incorporating several non-distributed sensors.

FIG. 9 illustrates a cross-sectional view of a non-distributed sensor disposed within a dead-end apparatus.

### DESCRIPTION

This disclosure relates to systems and methods for the operation of an overhead electrical line. As used herein, the term overhead electrical line encompasses both overhead transmission lines and overhead distribution lines. Transmission lines are electrical lines that are configured to carry relatively high voltage electricity, e.g., 60 kV or greater, over long distances such as from a power generation source to a substation, where transformers are used to decrease the voltage from the transmission line and supply electricity to one or more distribution lines with the lower voltage electricity. Distribution lines are overhead electrical lines that are configured to distribute lower voltage electricity, e.g., less than 60 kV, on a more localized basis such as from a substation to surrounding communities, e.g., to residential neighborhoods and commercial complexes. In either event, overhead electrical lines include long electrically conducting cables that are supported above the ground by a series of support towers, sometimes referred to as pylons. As is described below, overhead electrical lines also include other critical components such as hardware for attaching the electrical cables to the support towers and insulators for preventing the leakage of electrical current from the electrical cables to the underlying terrain.

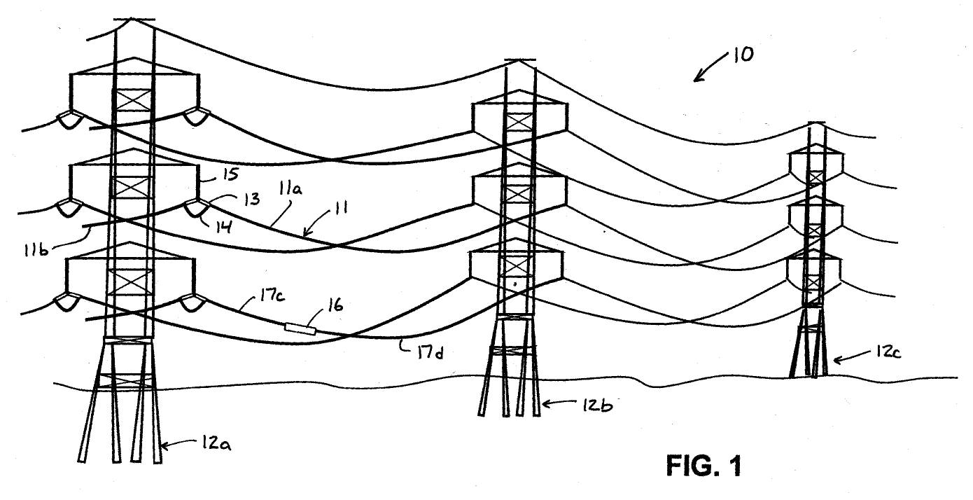

FIG. 1 illustrates such an overhead electrical line 10, specifically an overhead transmission line. Although the following description is directed primarily to systems and methods for the operation of a transmission line, it is to be understood that the systems and methods may similarly be employed with distribution lines, either separately from a transmission line or in combination with a transmission line. The transmission line 10 includes electrical cables, e.g., electrical cable 11, that conduct electricity and that are supported above the terrain by two or more support towers such as support towers 12a/12b/12c. The electrical cables may have a length of at least about 20 meters, such as at least about 250 meters, such as at least about 500 meters or even at least about one kilometer.

Nonetheless, transmission lines may span many kilometers, requiring extremely long lengths of joined electrical cables. As a result, the electrical line is typically comprised of two or more electrical cable segments that are mechanically and electrically joined to form a continuous electrical pathway along the transmission line. Further, a transmission line includes a plurality of spaced-apart electrical cables, typically in groups of three, to support the transmission of alternating current (AC) in three phases. Although the present disclosure refers primarily to AC transmission of electricity, the systems and methods disclosed herein are also useful for the operation of direct current (DC) electrical lines.

As noted above, one function of the support towers is to safely elevate the electrical cables above the terrain. In this regard, the electrical cables are attached to the support towers using different types of hardware. Some of the support towers are referred to as dead-end towers or anchor towers, such as dead-end tower 12a. Such towers are located at termination points, e.g., at substations or at locations where the electrical line is routed underground. Dead-end towers such as dead-end tower 12a may also be required where the electrical line changes direction, e.g., makes a turn, crosses a roadway or other structure where there is a high risk of damage or injury if the electrical cable fails, or at regular intervals in a long straight path. In such instances, two electrical cable segments are mechanically attached to the dead-end tower under high tension and are electrically connected to form a continuous electrical pathway. As illustrated in FIG. 1, electrical cable segment 11a is secured (e.g., anchored) to dead-end tower 12a using a dead-end termination 13 (e.g., a tension clamp) and is electrically connected to an adjacent electrical cable segment 11b through an electrical jumper 14. The electrical cable segments 11a/11b are insulated from the dead-end tower 12a by an insulator string 15.

Another hardware component that may be used in a transmission line is referred to as a splice. While the length of a single overhead cable segment may be several thousand meters, a transmission line may span several hundred kilometers over which the electrical power must be transmitted. To span these distances, the linemen must often join two cable segments together. In this case, one or more splices may be utilized to join two electrical cable segments, e.g., between two dead-end towers. The splice functions as both a mechanical junction that holds the two ends of the electrical cable segments together and an electrical junction allowing the electric current to flow through the splice. As illustrated in FIG. 1, a splice 16 operatively connects electrical cable segment 17c to electrical cable segment 17d to form a mechanical junction and a continuous electrical pathway.

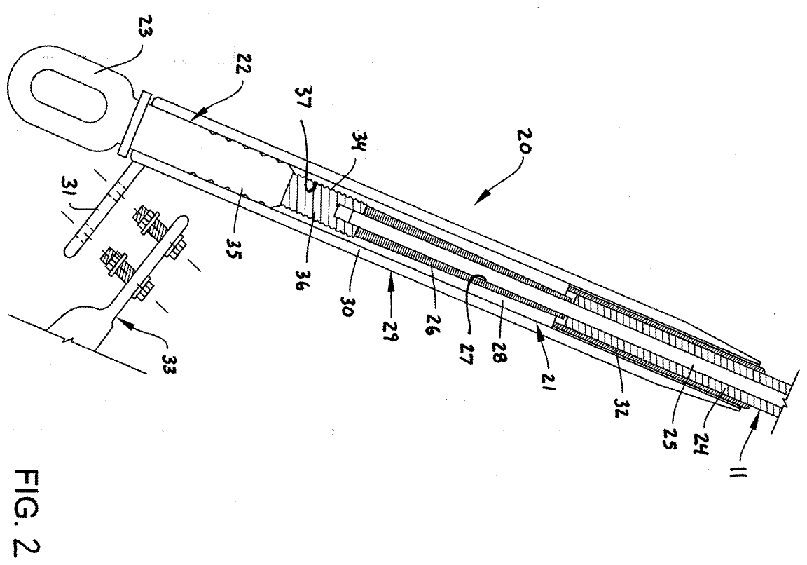

FIG. 2 illustrates a cross-section of an assembled termination apparatus (e.g., a dead-end) such as dead-end 13 illustrated in FIG. 1. The dead-end 20 illustrated in FIG. 2 is similar to that illustrated and described in PCT Publication No. WO 2005/041358 by Bryant and in U.S. Pat. No. 8,022,301 by Bryant et al., each of which is incorporated herein by reference in its entirety.

Broadly characterized, the dead-end 20 includes a gripping assembly 21 and a connector 22 for anchoring the dead-end 20, e.g., to a tower as illustrated in FIG. 1, with a fastener 23 disposed at a proximal end of the dead-end 20. At the distal end of the dead-end 20, opposite the fastener 23, the dead-end 20 is operatively connected to an overhead electrical cable segment 11 that includes an electrical conductor 24 that surrounds and is supported by a strength member 25, e.g., a fiber-reinforced composite strength member, sometimes referred to as a core.

The gripping assembly 21 tightly grips the strength member 25 to secure the overhead electrical cable segment 11 to the dead-end 20. As illustrated in FIG. 2, the gripping assembly 21 includes a compression-type fitting (e.g., a wedge-type fitting), specifically a collet 26 having a collet lumen 27 (e.g., a bore) that surrounds and grips onto the strength member 25. The collet 26 is disposed in a collet housing 28, and as the electrical cable segment 11 is tensioned (e.g., is pulled onto support towers), friction develops between the strength member 25 and the collet 26 as the collet is pulled further into the collet housing 28. The outer conical shape of the collet 26 and the mating inner funnel shape of the collet housing 28 increase the compression on the strength member 25, ensuring that the strength member does not slip out of the collet 26 and therefore that the overhead electrical cable segment 11 is secured to the dead-end 20.

The connector 22 includes the fastener 23 (e.g., an eyebolt) and gripping assembly mating threads 34 disposed at a gripping assembly end 36 of a connector body 35. The gripping assembly mating threads 34 are configured to operatively mate with connector mating threads 37 on an inner surface of the collet housing 28 to facilitate movement of the connector 22 against the collet 26, pushing the collet 26 into the collet housing 28 when the mating threads 34 and 37 are engaged and the connector 22 is rotated relative to the collet housing 28. This strengthens the compressive grip of the collet 26 onto the strength member 25, further securing the overhead electrical cable 11 to the dead-end 20. The fastener 23 is configured to be attached to a dead-end tower as illustrated in FIG. 1, to secure the dead-end 20 and therefore the electrical cable 11, to the dead-end tower.

As illustrated in FIG. 2, an outer sleeve 29 is disposed over the gripping assembly 21 and an end of the electrical cable segment 11. The outer sleeve 29 includes a conductive body 30 to facilitate a continuous electrical pathway between the electrical conductor 24 and a jumper plate 31. An inner sleeve 32 (e.g., a conductive inner sleeve) may be placed between the conductor 24 and the conductive body 30 to facilitate the electrical connection between the conductor and the conductive body. The conductive body 30 may be fabricated from aluminum and the jumper plate 31 may be integrally formed with or welded onto the conductive body. The jumper plate 31 is configured to attach to a connector plate 33 to facilitate the formation of an electrical pathway between the electrical cable segment 11 and another electrical cable segment (not illustrated), e.g., through a jumper cable as illustrated in FIG. 1.

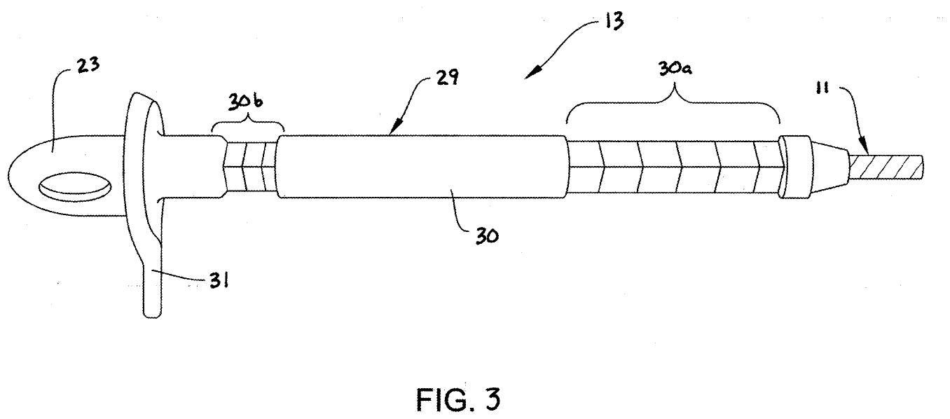

FIG. 3 illustrates a perspective view of a dead-end 13 that has been crimped (e.g., compressed) onto an overhead electrical cable segment 11. The dead-end 13 includes a connector having a fastener 23 that extends outwardly from a proximal end of an outer sleeve 29. A jumper plate 31 is integrally formed with the outer conductive sleeve body 30 for electrical connection to a connection plate as illustrated in FIG. 2. As illustrated in FIG. 3, the outer sleeve conductive body 30 is crimped over (e.g., crimped onto) two regions of the underlying structure, namely crimped sleeve body region 30a and crimped sleeve body region 30b. The crimped sleeve body region 30b is generally situated over an intermediate portion of the underlying connector and the crimped sleeve region 30a is generally situated over a portion of the electrical cable segment 11 (e.g., see FIG. 2). The compressive forces placed onto the outer sleeve body 29 during the crimping operation are transferred to the underlying components, i.e., to the connector under the crimped region 30b and to a portion of the electrical cable segment 11 under the crimped region 30a to permanently secure the conductive body 30 to the electrical cable segment 11 and to the underlying connector.

The dead-end broadly described with respect to FIGS. 2 and 3 can be utilized with various overhead electrical cable configurations. The dead-end illustrated in FIGS. 2 and 3 is particularly useful with overhead electrical cables having a fiber-reinforced composite strength member. For example, a compression wedge gripping element, e.g., having a collet disposed in a collet housing (e.g., FIG. 2), enables a fiber-reinforced composite strength member to be gripped under a high compressive force without significant risk of fracturing the composite material. However, those of skill in the art will recognize that other configurations for such dead-ends are disclosed in the art and the foregoing illustrations are merely examples of one configuration that may be used to secure an overhead electrical cable segment to a structure such as a support tower.

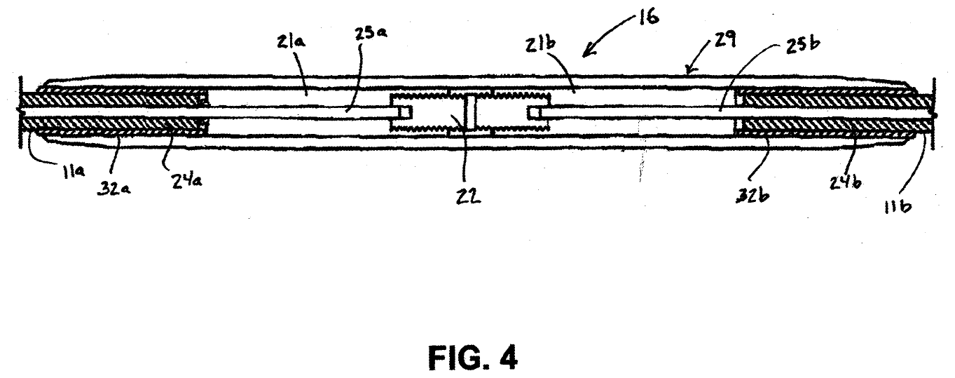

FIG. 4 illustrates a cross-sectional view of a splice 16, e.g., a splice as illustrated in FIG. 1. As illustrated in FIG. 1, a splice is configured to mechanically and electrically connect the ends of two overhead cable segments to form a continuous electrical pathway between the two cable segments. As illustrated in FIG. 4, the splice 16 connects two electrical cable segments 11a and 11b. The splice 16 includes gripping assemblies 21a and 21b that operatively grip electrical cable segments 11a and 11b, respectively. The gripping assemblies may include a collet and housing configuration as illustrated in FIG. 2, for example. To mechanically join the two electrical cable segments, the gripping assemblies 21a/21b are connected to, e.g., threadably engaged with, a single connector 22. To form a continuous electrical pathway between the electrical cables 11a/11b, e.g., between two electrical conductors 24a/24b, a conductive outer sleeve 29 is placed over the underlying structure and is crimped onto at least the connector body 22 and the ends of the electrical cables 24a and 24b. Conductive inner sleeves 32a/32b may be inserted between the conductors 24a/24b and the outer sleeve 29 to facilitate a robust electrical connection therebetween. As with the dead-ends illustrated in FIGS. 2 and 3, those of skill in the art will recognize that other configurations for splices are disclosed in the art and the foregoing illustration is merely one example that may be utilized to electrically and mechanically connect two electrical cable segments.

The systems and methods disclosed herein may be implemented with electrical lines that incorporate overhead electrical cables having a variety of configurations. One traditional configuration is referred to as aluminum conductor steel reinforced cable (ACSR) cable wherein outer aluminum conductor strands are supported by a strength member having a plurality of steel wires that are twisted together, e.g., stranded, to form the strength member. Other configurations implementing a strength member formed from a plurality of twisted metal wires include aluminum core steel supported (ACSS) cables. These and similar configurations are known to those of ordinary skill in the art.

While the systems and methods disclosed herein may be implemented with electrical lines that incorporate these types of overhead electrical cables, in certain embodiments the systems and methods are particularly useful when the electrical lines incorporate one or more electrical cable segments that utilize a fiber-reinforced composite strength member. As used herein, a fiber-reinforced composite strength member is a strength member that includes an elongate structural element that comprises reinforcing fibers in a binding matrix. Such composite materials offer many benefits including lightweight, advantageous mechanical properties such as a high tensile strength and a low coefficient of thermal expansion (CTE) as compared to metal strength elements such as steel wires, for example. Such a strength member may comprise a single (i.e., no more than one) fiber-reinforced strength element (e.g., a one-piece fiber-reinforced composite strength member), or may be comprised of several fiber-reinforced composite strength elements that are combined (e.g., twisted, stranded or otherwise bundled together) to form the strength member. As such, the present disclosure may use the terms strength member and strength element interchangeably, particularly where the strength member includes a single strength element.

The systems and methods disclosed herein may be utilized with electrical lines having one or more electrical cable segments that incorporate strength members and at least one distributed sensing element. A distributed sensing element is an elongate wire or strand that enables location-specific data to be obtained along a length of the distributed sensing element. In one particular characterization, the distributed sensing element comprises at least one optical fiber. As used herein, the term optical fiber refers to an elongate and continuous fiber that is configured to transmit incident light down a length of the fiber. Typically, glass optical fibers include a transmissive core and a cladding layer surrounding the core that is fabricated from a different material (e.g., having a different refractive index) to reduce the loss of light out of the transmissive core and through the exterior of the optical fiber. The optical fibers can be single mode optical fibers or a multimode optical fibers. A single mode optical fiber has a small diameter transmissive core (e.g., about 9 μm in diameter) surrounded by a cladding having a diameter of about 125 μm. Single mode fibers are configured to allow only one mode of light to propagate. A multimode optical fiber has a larger transmissive core (e.g., about 50 μm in diameter or larger) that allows multiple modes of light to propagate. The optical fibers may be fabricated entirely from one or more polymers. However, polymer optical fibers may not have sufficient optical attenuation and adequate heat resistance to withstand manufacture and/or use of the strength member incorporating the optical fiber. In this regard, glass optical fibers are generally preferred, e.g., for their low attenuation.

Although the present disclosure contemplates the use of other types of distributed sensing elements, this disclosure will generally refer to the use of optical fibers. However, it is to be understood that the present disclosure is not strictly limited to use with optical fibers as the distributed sensing element and other distributed sensing elements may be utilized.

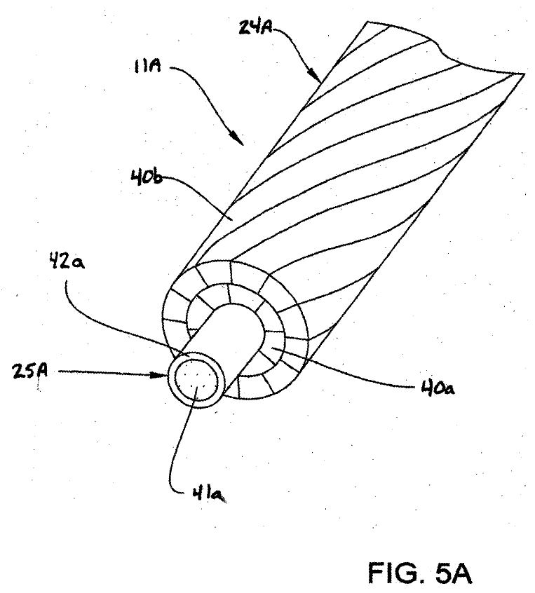

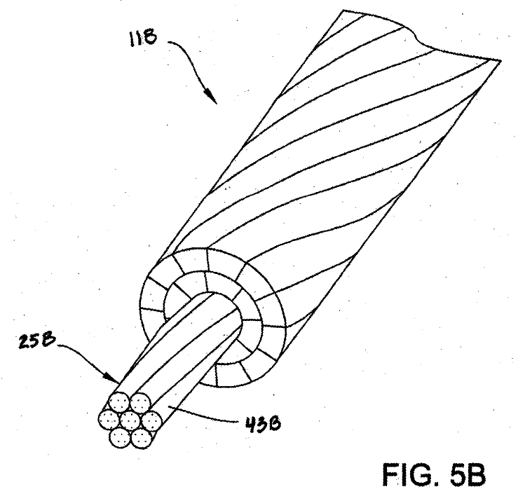

As noted above, overhead electrical cables typically include a central strength member and an electrical conductor disposed around and supported by the strength member. Although the strength member has traditionally been fabricated from steel, such steel strength members are increasingly being replaced by strength members fabricated from composite materials, particularly from fiber-reinforced composite materials, which offer many significant benefits. Such fiber-reinforced composite strength members may include a single fiber-reinforced composite strength element as is illustrated in FIG. 5A. Alternatively, the composite strength member may be comprised of a plurality of individual fiber-reinforced composite strength elements (e.g., individual rods) that are operatively combined (e.g., twisted or stranded together) to form the strength member, as is illustrated in FIG. 5B.

Referring to FIG. 5A, the overhead electrical cable 11A includes an electrical conductor 24A comprising a layer of first conductive strands 40a that are helically wrapped around a fiber-reinforced composite strength member 25A, which comprises a single fiber-reinforced composite strength element. A second layer of conductive strands 40b are helically wrapped around the first conductive strands 40a to increase the volume of the electrical conductor 24A. The conductive strands 40a/40b may be fabricated from conductive metals such as copper or aluminum, and for use in bare overhead electrical cables are typically fabricated from aluminum, e.g., hardened aluminum, annealed aluminum, and/or aluminum alloys. The conductive materials, e.g., aluminum, do not have sufficient mechanical properties (e.g., sufficient tensile strength) to be self-supporting when strung between support towers, thus necessitating the use of the strength member 25A. In the configuration illustrated in FIG. 5A, the fiber-reinforced composite strength member 25A includes a single strength element having a high tensile strength section 41a (e.g., comprising carbon fibers) surrounded by a galvanic layer 42a that prevents adverse reactions between the carbon in the high tensile strength section 41a and the aluminum strands 40a. The galvanic layer 42a comprises glass fibers that are also disposed in a binding matrix and is integrally formed, e.g., pultruded, with the high tensile strength section 41a. Alternatively, a galvanic layer may be formed around a high tensile strength section by wrapping a tape or disposing a polymer around the high tensile strength section.

FIG. 5B illustrates an embodiment of an overhead electrical cable 11B that is similar to the electrical cable illustrated in FIG. 5A, where the strength member 25B comprises a plurality of individual fiber-reinforced strength elements (e.g., strength element 43B) that are stranded together to form the strength member 25B. Although illustrated in FIG. 5B as including seven individual strength elements, multi-element strength members may include any number of strength elements that is suitable for a particular application. The individual strength elements may be formed with carbon fibers and each element may include a galvanic layer as illustrated in FIG. 5A. Alternatively, or in addition, the bundle of strength elements may be entirely surrounded by a galvanic layer 42a such as by wrapping an insulative tape around the bundle of strength elements. Examples of such multi-element composite strength members include, but are not limited to: the multi-element aluminum matrix composite strength member illustrated in U.S. Pat. No. 6,245,425 by Mccullough et al.; the multi-element carbon fiber strength member illustrated in U.S. Pat. No. 6,015,953 by Tosaka et al.; and the multi-element strength member illustrated in U.S. Pat. No. 9,685,257 by Daniel et al. Each of these U.S. patents is incorporated herein by reference in its entirety. Other configurations for the fiber-reinforced composite strength member may be utilized in the electrical cables.

As noted above, the fiber-reinforced composite from which the strength member is fabricated includes reinforcing fibers that are operatively disposed in a binding matrix. The reinforcing fibers may be substantially continuous reinforcing fibers that extend along the length of the fiber-reinforced composite, and/or may include short reinforcing fibers (e.g., fiber whiskers or chopped fibers) that are dispersed through the binding matrix. The reinforcing fibers may be selected from a wide range of materials, including but not limited to, carbon, glass, boron, metal oxides, metal carbides, high-strength polymers such as aramid fibers or fluoropolymer fibers, basalt fibers and the like. Carbon fibers are particularly advantageous in many applications due to their very high tensile strength, and/or due to their relatively low coefficient of thermal expansion (CTE).

The binding matrix may include, for example, a plastic (e.g., polymer) such as a thermoplastic polymer or a thermoset polymer. The binding matrix may also be a metallic matrix, such as an aluminum matrix. One example of an aluminum matrix fiber-reinforced composite is illustrated in U.S. Pat. No. 6,245,425 by Mccullough et al., which is incorporated herein by reference in its entirety.

One configuration of a composite strength member for an overhead electrical cable that is particularly advantageous is the ACCC® composite configuration that is available from CTC Global Corporation of Irvine, CA and is illustrated in U.S. Pat. No. 7,368,162 by Hiel et al., noted above. In the commercial embodiment of the ACCC® electrical cable, the strength member is a single element strength member of substantially circular cross-section that includes an inner core of substantially continuous reinforcing carbon fibers disposed in a polymer matrix. The core of carbon fibers is surrounded by a robust insulating layer of glass fibers that are also disposed in a polymer matrix and are selected to insulate the carbon fibers from the surrounding conductive aluminum strands. See FIG. 5A. The glass fibers also have a higher elastic modulus than the carbon fibers and provide bendability so that the strength member and the electrical cable can be wrapped upon a spool for storage and transportation.

Although the foregoing characteristics of a fiber-reinforced strength member are disclosed as being desirable for use in an overhead electrical cable, similar characteristics may also be desirable when the strength members disclosed herein are used in other structures, such as bridge cables and messenger cables.

Although not limited thereto, in certain embodiments the systems and methods for operating an overhead electrical line rely upon the implementation of at least one distributed sensor. As used herein, a distributed sensor is a sensor that is capable of obtaining data, e.g. making measurements, along a substantially continuous length of the sensor. For example, the distributed sensor may comprise an optical fiber that extends along a length of an electrical cable to enable detection of temperature or strain along the entire length of the electrical cable. As such, the data that is collected and analyzed from the distributed sensor may also include an identification of the location of the measurement along the distributed sensor. The distributed sensor may be associated with the electrical cable by being placed within the electrical cable. For example, a distributed sensor may be placed within the conductive strands along a length of the electrical cable. In one characterization, the optical fiber is associated with the strength member of at least one of the electrical cable segments. By operatively associating the optical fiber with a strength member, it may be possible to determine certain important properties of the strength member such as the strain that the strength member is experiencing at a particular location.

In this regard, at least one elongate and continuous optical fiber may be operatively associated with the fiber-reinforced composite strength member. In one configuration, the optical fiber may be embedded within the fiber-reinforced composite (e.g., within the binding matrix). The optical fiber may extend from a first end of the strength member to a second end of the strength member, e.g., such that the entire length of the optical fiber, and substantially the entire length of the overhead electrical cable, may be interrogated using the optical fiber. Through proper selection of the optical fiber(s) and placement of the optical fiber(s), the strength member and the electrical cable segment can be interrogated to assess the condition of the strength member. Although a single optical fiber may be utilized in an overhead electrical cable, the efficacy of the systems and methods disclosed herein may be improved by including multiple optical fibers wherein at least one of the optical fibers is associated with the strength member.

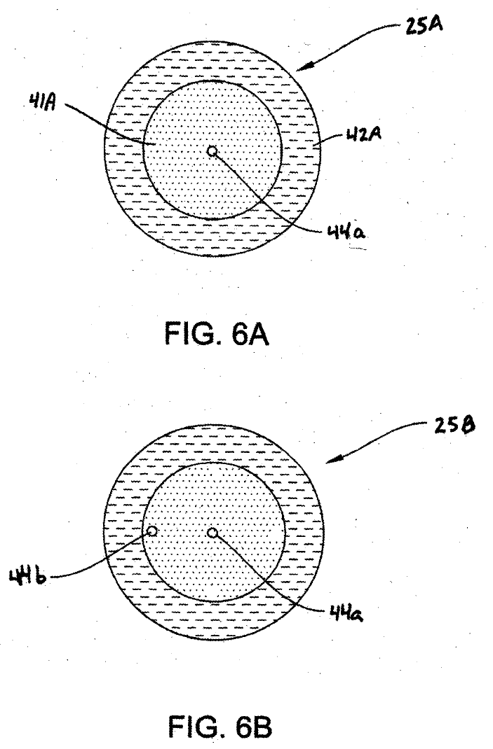

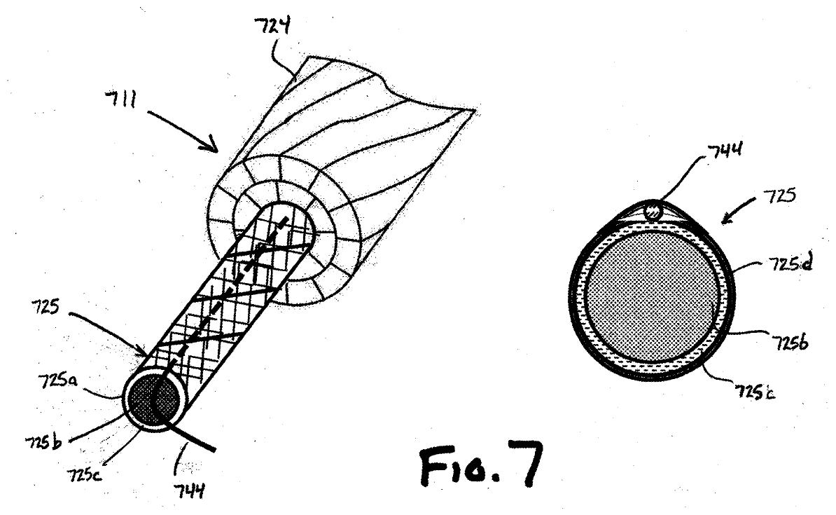

Referring to FIGS. 6A and 6B, cross-sectional views of single element fiber-reinforced composite strength members are illustrated. The configuration of the fiber-reinforced strength members is similar to the strength element illustrated in FIG. 5A, including an inner section of high tensile strength fibers surrounded by an outer layer of an insulative material, e.g., an inner section comprising carbon fibers surrounded by an outer galvanic layer comprising glass fibers. As illustrated in FIG. 6A, the fiber-reinforced composite strength member 25A includes a single optical fiber 44a that is centrally disposed within the strength member 25A, i.e., centrally disposed within the high strength section 41A. Stated another way, the optical fiber 44a is disposed substantially along a central axis of the strength member 25A. In the configuration illustrated in FIG. 6B, the strength member is configured in a similar manner as the configuration illustrated in FIG. 6A. As illustrated in FIG. 6B, the strength member 25B includes a second optical fiber 44b in addition to the optical fiber 44a. The optical fiber 44b is offset from the optical fiber 44a, i.e., is offset from a central axis of the strength member 25B. In any event, the placement of at least one optical fiber along a central axis of the strength member may advantageously reduce or eliminate the effect of bending modes upon the optical fiber. Examples of different configurations of optical fibers embedded in the fiber-reinforced composite strength member are illustrated in US Patent Publication No. 2021/0048469 by Dong et al., which is incorporated herein by reference in its entirety.

It will be appreciated that FIGS. 6A and 6B are merely illustrative of possible configurations wherein optical fibers are operatively associated with fiber-reinforced composite strength members. For example, the fiber-reinforced strength members may incorporate more than one or two optical fibers, such as three, four or more optical fibers. Such additional optical fibers may be used for enhanced measurement sensitivity, for redundancy or for other reasons. In any event, by incorporating the optical fiber(s) within the fiber-reinforced composite strength member, e.g., within the binding matrix, certain advantages may be realized. For example, the optical fiber is fully protected (e.g., shielded) from the exterior environment by the binding matrix, ensuring that natural or man-made environmental factors (e.g., impact stresses) will not significantly impair the performance of the sensing optical fiber. Further, the optical fiber is physically and intimately bound to the matrix within the fiber-reinforced composite such that forces that act upon the fiber-reinforced composite strength member (e.g., tensile strain) will be fully and consistently transmitted to the optical fiber along the entire length of the strength member, ensuring accurate distributed measurements.

A distributed sensing element, e.g., an optical fiber, may also be associated with a fiber-reinforced strength member, and hence with an electrical cable including the strength member, by alternative means. For example, one or more optical fibers may be affixed to an outer surface of the strength member along the length of the strength member. FIG. 7 illustrates a perspective view of one exemplary embodiment of an overhead electrical cable 711 and a cross-sectional view of the strength member assembly 725 according to this construction. The electrical cable 711 includes a strength member assembly 725 that includes a strength member 725a having a high tensile strength fiber-reinforced composite core 725b including carbon fibers and a galvanic layer 725c of glass fibers in a binding matrix. An electrical conductor 724 surrounds the strength member assembly 725. In the embodiment illustrated in FIG. 7, the strength member assembly 725 includes an optical fiber 744 that is linearly disposed along an outer surface of the strength member 725a. A tape layer 725d is wound around the strength member 725a and the optical fiber 744 to couple the optical fiber to the strength member and form the strength member assembly 725. Specifically, the tape layer 725d comprises a strip of tape that is helically wound around the strength member 725a in a manner such that the tape overlaps upon itself along seams such that the tape layer 725d covers the entire strength member (e.g., with no substantial gaps) and the optical fiber 744, and such that the tape layer 725d lies between the optical fiber 744 and the electrical conductor 724 along its length. It will be appreciated that the construction illustrated in FIG. 7 is merely exemplary and that optical fibers may be associated with electrical cables using other constructions. Examples of such other constructions are disclosed in PCT Publication No. WO 2021/222663 by Webb et al. which is incorporated herein by reference in its entirety.

The fiber-reinforced strength elements described above may be fabricated by means known to those of skill in the art. In one example, the fiber-reinforced composite strength member is formed by pultrusion process whereby tows of continuous reinforcing fibers (e.g., carbon and glass fibers) are pulled through a binding matrix material (e.g., through an epoxy resin bath), which is subsequently cured to bind the fibers and form a fiber-reinforced composite. Optical fibers are provided by the manufacturer in continuous lengths (e.g., of many thousands of meters) on spools in a manner similar to the fiber tows (e.g., carbon fiber tows and glass fiber tows). Therefore, the optical fibers can be integrated into the pultrusion process along with the reinforcing fibers.

The optical fibers may be operatively coupled to an interrogation device, e.g., that includes a coherent light source (e.g., a pump laser source) to enable the light to be passed (e.g., pulsed) into the optical fiber in a controlled manner. The light source may be configured to send a signal (e.g., a pulse) down the optical fiber, and the interrogation (e.g., the measurement) of the condition in the optical fiber is performed by analyzing light that is backscattered by the optical fiber. In this regard, the interrogation device may include a signal detector such as an interferometer, that is configured to detect the backscattered light signals.

For example, the components of the backscattered light can be categorized as Rayleigh components, Brillouin components and Raman components. The backscattered Rayleigh components have the same frequency (i.e., same wavelength) as the primary light source and have a relatively high intensity. The backscattered Rayleigh components can be analyzed to determine the length of the optical fiber by using Optical Time Domain Reflectometry (OTDR). Thus, backscattered Rayleigh components may be used to detect a break in the optical fiber indicating possible damage to the fiber-reinforced composite strength member. However, the backscattered Rayleigh components are not capable of providing any further significant information about the conditions of the optical fiber.

In one characterization, the interrogation device implements the OTDR analysis of at least one of Raman backscattered light components (e.g., a Raman distributed sensor) and Brillouin backscattered light components (e.g., a Brillouin distributed sensor). Both Raman and Brillouin distributed sensor systems make use of a non-linear interaction between the primary light signal and the optical fiber. When a primary light signal of known wavelength is input to an optical fiber, a very small amount of the light signal is scattered back (e.g., a backscattered light signal) at every point along the optical fiber. The backscattered light contains shifted components at wavelengths that are different than the primary light signal. Light components that are shifted to a longer wavelength (i.e., lower energy) are referred to as Stokes components, whereas light components that are shifted to a shorter wavelength (i.e., higher energy) are referred to as anti-Stokes components. These shifted backscattered light components can be detected and analyzed to ascertain information about the local conditions of the optical fiber, such as its strain and temperature at different points along the length of optical fiber.

In one configuration, at least one of the optical fibers is utilized as a Raman distributed temperature sensor. In a Raman distributed temperature sensor, the interaction between the primary light signal (e.g., the pump laser signal) and optical phonons in the optical fiber material (e.g., silica) creates two backscattered light components in the backscattered light spectrum, Raman Stokes and Raman anti-Stokes. The Raman anti-Stokes component is temperature dependent, i.e., the intensity of the Raman anti-Stokes component increases with increasing temperature of the sensing optical fiber. As a result, the relative intensity of the Raman Stokes and the Raman anti-Stokes backscattered light components can be measured and used to determine a temperature of the sensing optical fiber. The Raman Stokes and Raman anti-Stokes backscattered light components can be detected by a signal detector such as an interferometer or a dispersive spectrometer, which may be a component of the interrogation device.

The position of the temperature reading along the length of the optical fiber can also be determined from the Raman backscattered light components. When a pulsed light signal is used to interrogate the optical fiber, the back-scattered intensity of the Raman Stokes and Raman anti-Stokes backscattered light components can be recorded as a function of time (e.g., “round trip” time), enabling the capture of a temperature profile along the length of the optical fiber, i.e., along the length of the fiber-reinforced composite strength member.

In one example, the optical fiber operatively associated with the fiber-reinforced composite strength member includes a Raman distributed temperature sensor having a multi-mode sensing optical fiber. The multi-mode sensing optical fiber having a high numeric aperture may increase the intensity of the backscattered light which can be important due to the relatively low magnitude of the Raman backscattered light signals.

In another configuration, the interrogation device incorporates Brillouin distributed sensing to interrogate the optical fiber. Brillouin distributed sensors utilize Brillouin backscattering, which is the result of an interaction between the primary light signal and time dependent optical density variations within the optical fiber (i.e., acoustic phonons). The acoustic phonons create a periodic modulation of the refractive index (e.g., the optical density) of the sensing optical fiber material. Brillouin scattering occurs when the propagating primary light signal is diffracted back by this moving “grating,” resulting in a frequency and wavelength shifted component in the backscattered light signal.

As the temperature of the optical fiber increases, the wavelength of the Brillouin backscattered components shifts further away from the primary wavelength. This wavelength shift can be utilized to determine the temperature of the optical fiber. As with a Raman distributed temperature sensor, the location of the temperature reading along the length of the optical fiber can be determined using time of flight information for the backscattered light signal.

Unlike Raman distributed sensors, however, Brillouin distributed sensors may also be utilized to detect the strain (e.g., tensile strain) in the optical fiber. That is, a change in the strain within the sensing optical fiber will also cause a wavelength shift in the Brillouin backscattered light components due to a change in the optical density of the sensing optical fiber. As a result, the strain that is experienced by the sensing optical fiber at any point along its length can be determined, and hence the strain experienced by the fiber-reinforced composite strength member can also be determined.

Brillouin distributed sensors may be configured to implement a spontaneous Brillouin-based technique, i.e., Brillouin optical time domain reflectometry (BOTDR), or a stimulated Brillouin based technique, i.e., Brillouin optical time domain analysis (BOTDA). One advantage of a BOTDR configuration is that a single coherent pump light source can be utilized, i.e., at one end of the sensing optical fiber. In certain systems, BOTDR also offers the capability of simultaneously measuring the temperature and strain in a single optical fiber. However, the detected backscattered light signal is typically very weak, requiring signal processing and a long integration time.

In another configuration, the Brillouin distributed interrogation device implements a BOTDA technique. In BOTDA, a counter-propagating input light signal (sometimes referred to as a “probe” signal or a “counter wave” signal) having a wavelength difference that is equal to the Brillouin shift is used. This probe signal reinforces the phonon population in the sensing optical fiber, resulting in a higher signal-to-noise ratio. When the primary (pump) light signal is a short pulse, and its reflected intensity is analyzed in terms of flight time and wavelength shift, it is possible to obtain a profile of the Brillouin shift along the length of the sensing optical fiber. BOTDA techniques generally require the two counter propagating light signal wavelengths to be very stable (e.g., synchronized laser sources). Advantageously, a temperature resolution of less than 1.0° C. or even less than 0.5° C. may be achieved. Further, very small strain shifts experienced by the sensing optical fiber may be detected.

Thus, an interrogation device implementing Brillouin distributed sensing is useful for temperature monitoring and is uniquely suited for the measurement of strain. In this regard, it is typically necessary to know the wavelength shift in the optical fiber at a reference temperature in order to calculate the absolute temperature at any point along the optical fiber. It is also typically necessary to know the wavelength shift of the unstrained fiber in order to enable an absolute strain measurement. In addition to temperature and strain, distributed sensing optical fibers may be used to detect vibrations or to detect breaks in the fiber-reinforced composite strength member.

According to the present disclosure, the properties of one or more overhead electrical cable segments may be interrogated (e.g., monitored) in real time during operation of the electrical line, e.g., during operation of the electrical grid, thereby enabling the systems and methods disclosed herein to actively monitor and operate the electrical lines in real time. Such systems and methods may include the continuous or semi-continuous interrogation of the overhead electrical cables to detect, for example, temperature conditions, strain conditions, mechanical load and/or elongation of the overhead electrical cables and acting in response to certain identified conditions. From a determination of these conditions, other conditions and/or states may be determined, such as the sag of a particular electrical cable segment or the electrical current carried by an electrical cable segment.

One characteristic of such interrogation devices, e.g., OTDR interrogation devices, is that the interrogation device must be calibrated to ensure that the information received by the interrogation device is accurately converted to a line condition value, e.g., a temperature value, a strain value, etc. during operation of the electrical line. In this regard, one or more calibration coefficients must be determined and implemented to accurately convert the raw data to the desired line condition value. Such a determination of the calibration coefficients can be determined prior to energizing the electrical line or at any point during operation of the electrical line as necessary or desired. Further, a line operator may desire that a line condition value that is determined by an interrogation device is accurate by corroborating that line condition value with an independently determined value.

In one embodiment of the present disclosure, a method for the operation of an overhead electrical line is disclosed wherein measurements are made by a distributed sensing element associated with the overhead electrical line and those measurements are corroborated, e.g., are validated, using one or more non-distributed sensors.

Thus, in some embodiments, one or more non-distributed sensors are utilized in conjunction with the distributed sensors. Non-distributed sensors are sensors that are disposed discretely, e.g., in isolation, at intervals along the electrical line, e.g., in proximity to an electrical cable. Examples of non-distributed sensors that may be useful for obtaining a temperature of an electrical cable include, but are not limited to, thermocouples and infrared cameras. Further, environmental sensors such as wind stations, humidity sensors and the like may be incorporated to collect data, e.g., for further refinement of the measured values.

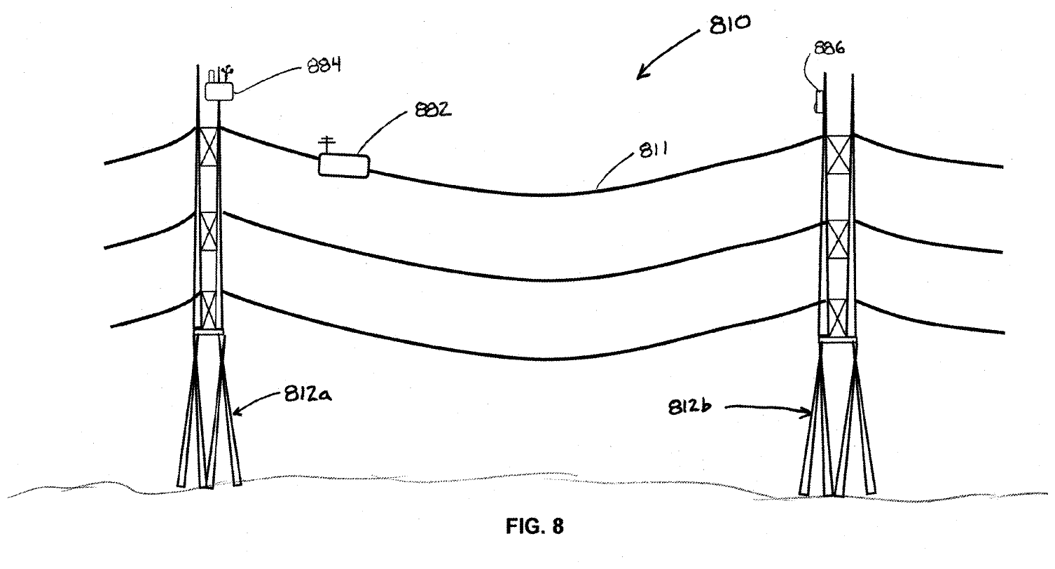

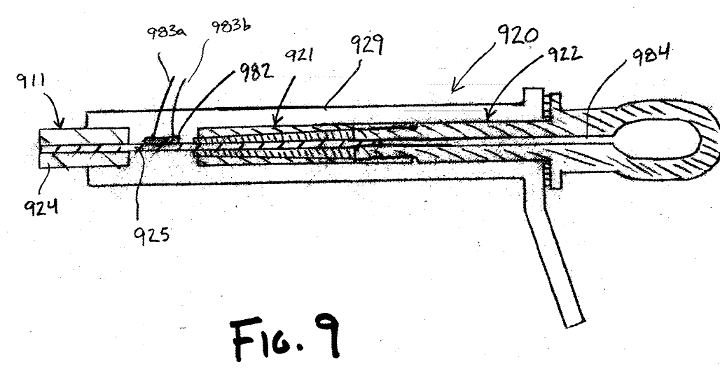

FIG. 8 illustrates a portion of an overhead electrical line that incorporates several non-distributed sensors. The electrical line 810 includes a segment of an overhead electrical cable 811 that lies between two support towers 812a and 812b. Attached directly to the electrical cable 811 is a first non-distributed sensor 882. The non-distributed sensor 882 may be characterized as a multi-functional sensor, e.g., a sensor that is capable of detecting more than one property of the electrical cable 811. One example of such a multi-functional sensor is the TLM Transmission Line Monitor available from Lindsey Manufacturing Co., Azusa, CA and the multi-functional sensor illustrated in US Patent Pub. No. 2020/0209283 by Mohr et al., which is incorporated herein by reference in its entirety. Such multi-functional sensors may be capable of detecting cable clearance above the terrain, cable sag (e.g., using an inclination sensor), electrical current and temperature. These units are self-powered, e.g., drawing power from the electrical cable, and typically include an antenna for the transmission of data, e.g., using satellite or wireless communication technology.

In some characterizations, the non-distributed sensor is not directly attached to the overhead electrical cable. For example, FIG. 8 also illustrates a camera 886 that is mounted to the support tower 821b in a manner to permit the camera to image the overhead electrical cable 811. The camera 886 may include an infrared capability to enable the camera to detect the temperature of the electrical cable 811. The camera 886 may also include visible imaging capability, e.g., such that image analysis can indicate the sag of the electrical cable 811. As with the multi-functional sensor 882, the camera 886 may include an antenna or similar device for wireless communication of data.

It will also be appreciated that non-distributed sensors may be utilized to collect data that is not directly obtained from the overhead electrical cable. For example, FIG. 8 illustrates a weather station 884 that is operatively attached to the support tower. Such a weather station 884 may be capable of detecting ambient conditions such as wind speed, wind direction, solar radiation level, humidity, and the like. As these ambient conditions may influence the conditions of the electrical cable, the knowledge of these conditions may be useful for assessing the properties of the electrical cable, e.g., using a distributed sensor.

Other non-distributed sensors may be attached to the electrical cable in a manner that protects the sensor from the external environment, and/or in a manner that enables the sensor to detect a particular condition of the electrical cable. FIG. 9 illustrates one embodiment of such a non-distributed sensor. As illustrated in FIG. 9, a dead-end apparatus 920 secures an overhead electrical cable 911, e.g., in manner similar to the dead-end apparatus illustrated in FIG. 2. A gripping assembly 921 is secured to a strength member 925, e.g., to a segment of the strength member that has been stripped of the electrical conductor 924 to expose the strength member. The sensor 982 is attached directly to that exposed portion of strength member 925, e.g., using an epoxy or other means of attachment. In one characterization, the sensor 982 is a strain sensor that is capable of measuring the strain of the strength member when it is coupled to the strength member. Because the sensor 982 is located between the gripping assembly 921 and the electrical conductor 924, the strain under the sensor will be indicative of the strain experienced by the entire electrical cable 911. It also advantageous that when the dead-end apparatus is installed, the sensor 982 will be protected from the environment, e.g., by the outer sleeve 929. In this regard, access to the sensor 982 may be provided by leads 983a/983b, e.g., that are ported through the outer sleeve 929 as illustrated, or are ported back through the gripping assembly 921 and connector 922 for access through a port 984.

As is disclosed above, the overhead electrical line is operatively strung onto support towers and includes at least a first overhead electrical cable as illustrated in FIG. 1. The overhead electrical cable includes a strength member and an electrical conductor surrounding the strength member. The strength member may be fabricated from metals such as steel or aluminum, e.g., in an ACSR configuration. In certain configurations, the electrical cable includes a fiber-reinforced composite strength member. The fiber-reinforced composite strength member may include a matrix and reinforcing fibers disposed within the matrix. For example, the matrix may be a polymer matrix, such as a thermoplastic matrix or a thermoset matrix. Alternatively, the matrix may be formed from a metal such as aluminum. The reinforcing fibers may include various types of fiber materials such as carbon fibers, glass fibers, aluminum oxide fibers, and the like. Further, the strength member may include a single composite strength element, e.g., as illustrated in FIG. 5A, or may include a plurality of strength elements, e.g., as illustrated in FIG. 5B.

The overhead electrical cable includes at least a first sensing element, and may include two or more sensing elements. In one configuration, the sending element extends along substantially the entire length of the overhead electrical cable, e.g., from a first end of the electrical cable to a second end of the electrical cable. In certain constructions, the distributed sensing element comprises an optical fiber. The optical fiber may be attached to a surface of the strength member, e.g., as illustrated in FIG. 7 above, or may be embedded within the strength member, e.g., as illustrated in FIGS. 6A-6B above. Alternatively, or in addition to, one or more optical fibers may be placed within the conductor layers of the overhead electrical cable. In any event, the one or more optical fibers may be a glass optical fiber, e.g., a multi-mode or a single mode glass optical fiber.

The overhead electrical cable may have a relatively short length, e.g., at least about 10 meters and not greater than about 30 meters, e.g., when utilized as a drop into a power substation or where the electrical cable passes over critical infrastructure. More commonly, the overhead electrical cable will have a length of at least about 50 meters, such as at least about 100 meters, at least about 250 meters or even at least about 500 meters. Typically, the overhead electrical cable will have a length that does not exceed about 10 kilometers, such as not greater than about 5 kilometers. The length of the overhead electrical cable will be determined by the number of instances that the strength member must be secured to a dead end or splice along the length of the electrical line, which may be 100s of kilometers in length.

The method for corroboration includes obtaining distributed condition data from the distributed sensing element, e.g., from the optical fiber. The distributed condition data may include distributed cable temperature data and/or distributed cable strain data. Both distributed temperature data and distributed strain data may be obtained from a distributed sensing element, e.g., from an optical fiber, using an interrogation device such as an OTDR device, e.g., a BOTDR device, as is disclosed above. The distributed condition data is collected by the interrogation device from the distributed sensing element at a point in time which may be recorded and associated with the collected data. In addition, first location data is collected and associated with the distributed condition data to associate a linear position along the electrical cable with the distributed condition data. The linear precision of the location data is subject to variability depending upon a number of factors, including the amount of time over which the distributed data is collected. Typically, the longer the distributed data is collected the more precise the measurement with respect to the linear position of the data. Thus, the location data may identify a linear segment along the overhead electrical cable, as opposed to a precise point. Stated another way, when condition data such as temperature data is collected, that condition data may be characterized as occurring within a length of the electrical cable between two points, e.g., within a linear segment of the electrical cable. In one characterization, the linear segment has a length of not greater than about 25 meters, such as not greater than about 20 meters, such as not greater than about 15 meters, such as not greater than about 10 meters, or even not greater than about 5 meters, such as not greater than about 3 meters.

After collection of the distributed condition data, a first distributed condition value is determined, e.g., is calculated, from the first distributed condition data. Stated another way, an interrogation device such as an OTDR device is configured to collect data from the sensing element, e.g., relating to wavelength, frequency and time of flight of returning light pulses, and to calculate a condition from the data, such as a temperature or an amount of strain. Typically, the OTDR device must be programmed with one or more calibration coefficients for the accurate calculation of a condition based on the collected data. Such calibration coefficients may be input to the interrogation device before installation of the overhead electrical cable.

While distributed condition data is highly valuable for the assessment of the state of an overhead electrical cable along its length, the collected data is sensitive to changes in the overhead electrical cable, e.g., to the effects of the environment and operating conditions of the overhead electrical cable over time. Therefore, the condition of the electrical cable may cause the collected data values to deviate over time from the actual line conditions in a manner such that the calculation of the distributed condition from the collected data becomes unreliable.

According to the present method, non-distributed condition data is collected from a non-distributed sensor that is located proximate to the overhead electrical cable, e.g., is located proximate to, e.g., near or within the linear segment of the distributed sensing element from which the distributed data is collected. For example, the collected non-distributed condition data may also include data selected from temperature data and/or strain data. A non-distributed condition value may be determined from the collected data. In one characterization, the non-distributed condition value is used as a reference condition value for that condition. Stated another way, if the non-distributed condition value is a temperature, and the temperature from the non-distributed sensor is calculated to be 100° C., then the reference condition value is set to 100° C.

In one implementation, a condition value deviation is calculated from the first distributed condition value and the reference condition value. For example, if the first distributed condition value is 120° C. and the reference condition value is 100° C., the condition value deviation is about 20° C., or about +20%. As a result of this deviation, the first interrogation device may be adjusted, e.g., with new calibration coefficients, to reduce the condition deviation value so that both the distributed sensor and the non-distributed sensor produce approximately the same value.

In another refinement, a second non-distributed sensor may be utilized to determine the reference value for the condition. The second non-distributed sensor may be co-located with the first non-distributed sensor, e.g., may be placed proximate, e.g., adjacent, to the first non-distributed sensor. If both the first non-distributed sensor and the second non-distributed sensor are in agreement with respect to the condition value, then that condition value may be set as the reference value. If the non-distributed sensors are not in agreement, e.g., if the measured temperatures deviate by more than several percent, the value of the non-distributed sensor may be considered. If the distributed sensing element and one of the non-distributed sensors are in agreement, that condition value may be taken as a reference value and as an indication that no adjustment to the interrogation device is necessary. In this case, it may be desirable to investigate the second non-distributed sensor for repair or replacement.

When the line condition that is being determined is cable temperature, the non-distributed sensor may include a thermocouple. Thermocouples are utilized to calculate a temperature based upon a voltage that develops at the junction of two dissimilar metals. Thermocouples are considered to be highly reliable for accurate temperature measurements over a broad range of temperatures. In one embodiment, heat may be applied to the portion of the first overhead electrical cable that includes the first non-distributed sensor while obtaining the first distributed condition data and the first non-distributed condition data from the portion of the first overhead electrical cable. This technique artificially heats the cable in this position so that a more accurate reading from the distributed sensor may be obtained,, e.g., by calibrating and/or corroborating based upon readings from the non-distributed sensor.

When the condition being interrogated is cable temperature, the acceptable deviation value that will initiate an adjustment of the interrogation device may be predetermined. For example, the acceptable deviation value may be not greater than about 20° C. absolute, e.g., within ±20° C. In another characterization, the acceptable deviation is not greater than about 15° C. absolute, such as not greater than about 10° C. absolute, or even not greater than about 5° C. absolute.

In certain implementations, the strain of the overhead cable, e.g., the strain of the strength member, may be determined using the non-distributed sensing element. In this regard, the non-distributed sensor may include a strain gauge, e.g., a strain gauge that is operatively affixed to the strength member so that the strain experienced by the strength member is transferred to the strain gauge. See FIG. 9, for example. Alternatively, or in addition to a strain gauge, the non-distributed sensor may include a Fiber Bragg Grating (“FBG”). Further, the non-distributed sensor may include a load cell affixed to the first overhead electrical cable to calculate the strain in the strength member.

As is discussed above, the adjustment to the distributed sensor to reduce the condition deviation value may be performed when the condition deviation value is greater than a predetermined acceptable deviation value. In one implementation where the condition is strain, the acceptable deviation value is a strain value of not greater than about 0.01% absolute, e.g., within ±0.01%, such as not greater than about 0.005% absolute, such as not greater than about 0.001% absolute.

In one particular characterization, the overhead electrical line includes a dead end assembly securing the first overhead electrical cable to a support tower, wherein the non-distributed sensor, e.g., the strain gauge, is disposed within the dead end assembly, as is illustrated in FIG. 9. In this manner, the strain gauge may be placed on the strength member in a section where the electrical conductor is stripped away from the strength member. Further, the strain gauge may be accessed through the hardware, e.g., through the dead end, by running wires from the strain gauge and through the hardware to provide access.

In any event, the non-distributed sensor may collect data from the overhead electrical cable in a remote manner, e.g., where the non-distributed sensor is not in direct contact with the electrical cable. For example, the temperature of an overhead electrical cable may be determined using an infrared camera that is focused on the electrical cable. In one characterization, the non-distributed sensor is operatively attached to the overhead electrical cable to obtain the non-distributed condition data directly from the electrical cable. For example, thermocouples and strain gauges may be operatively attached to the electrical cable, such as by attaching to the conductive layer or by attaching to the strength member. In this regard, the non-distributed sensor may located within the first linear segment. In this regard, the temperature or strain may be measured by the non-distributed sensor within a linear segment that is known to include the non-distributed sensor. Non-distributed sensors may transmit data using known methods such as satellite transmission and/or cellular wireless transmission. The sensors may be powered directly by the overhead electrical cable, e.g., by inductive power. See FIG. 8.

In another characterization, a non-distributed sensor may be utilized that incorporates multiple functionalities. For example, a non-distributed sensor may be capable of measuring cable temperature as well as other parameters such as electrical current, vibration, line sag and/or ground clearance. See, for example, the TLM Transmission Line Conductor Monitor available from Lindsey Manufacturing Company of Azusa, California and US Patent Publication No. 2020/0209283 by Mohr et al., which is incorporated herein by reference in its entirety. The collection of additional condition data such as electrical current, line sag and the like may be used to supplement the calculations of temperature and strain to provide a more comprehensive assessment of the electrical line. See FIG. 8.

In another embodiment, a system is disclosed that is configured for the operation of an overhead electrical line. For example, the system may include an overhead electrical line that is operatively strung onto support towers, where the overhead electrical line comprises a first overhead electrical cable comprising a strength member and an electrical conductor surrounding the strength member. A first distributed sensing element extends along a length of the first overhead electrical cable, e.g., where the first distributed sensing element includes an optical fiber. An interrogation device, such as an OTDR, is operatively attached to the optical fiber. At least a first non-distributed sensor is located proximate the first overhead electrical cable, e.g., in a manner to detect a condition of the electrical cable. For example, the first non-distributed sensor may be selected from a temperature sensor and a strain sensor, e.g., where the first non-distributed sensor is configured to measure at least one of a temperature value or a strain value of the overhead electrical cable. The system thus enables the foregoing methods to be implemented, e.g., calibration of the interrogation device and/or corroboration of distributed sensor values with non-distributed sensor values.

In another embodiment of the present disclosure, a non-distributed sensor, e.g., a non-distributed temperature sensor, may be utilized to extrapolate a value determined by a distributed sensing element, e.g., a distributed temperature value, to another portion of the electrical cable. For example, when a distributed sensing element such as an optical fiber is embedded in a fiber-reinforced composite strength member, the temperature measured by the distributed sensing element within the strength member may not be an accurate measure of the temperature of the conductive strands surrounding the strength member. A non-distributed sensor that is placed on or near the conductive strands and that accurately measures the temperature of the conductive strands may be used as a reference point so that the temperature of the strength member determined using the distributed sensing element may be extrapolated to provide a temperature of the conductive strands. Other data, such as wind or solar data collected from a weather station, may also be utilized to extrapolate the temperature value determined using the distributed sensing element.

While various embodiments of methods for operating an electrical line by corroborating distributed measurements have been described in detail, it is apparent that modifications and adaptations of those embodiments will occur to those skilled in the art. However, it is to be expressly understood that such modifications and adaptations are within the spirit and scope of the present disclosure.

What is claimed is:

1. A method for the operation of an overhead electrical line that is operatively strung onto support towers, the overhead electrical line comprising a first overhead electrical cable comprising a strength member and an electrical conductor surrounding the strength member, the method comprising the steps of:
obtaining first distributed condition data at a first time from a first distributed sensing element that extends along a length of the first overhead electrical cable, the first distributed condition data comprising at least one of first distributed cable temperature data and first distributed cable strain data;
obtaining first location data associated with the first distributed condition data, the first location data identifying a first linear segment of the first distributed sensing element, wherein the steps of obtaining the first distributed condition data and obtaining the first location data comprise interrogating the first distributed sensing element using an interrogation device that is operatively attached to the first distributed sensing element;
determining a first distributed condition value from the first distributed condition data;
obtaining first non-distributed condition data from a first non-distributed sensor that is located proximate to the first linear segment of the first distributed sensing element, the first non-distributed condition data comprising data selected from the group consisting of first non-distributed cable temperature data and first non-distributed cable strain data;
determining a non-distributed condition value from at least the first non-distributed condition data; and
adjusting the interrogation device to reduce a difference between the first distributed condition value and the first non-distributed condition value.

2. The method recited in claim 1, wherein the strength member is a fiber-reinforced composite strength member.

3. The method recited in claim 2, wherein the fiber-reinforced strength member comprises reinforcing fibers in a polymer matrix.

4. The method recited in claim 3, wherein the fiber-reinforced strength member comprises reinforcing fibers in a thermoplastic matrix.

5. The method recited in claim 3, wherein the fiber-reinforced strength member comprises reinforcing fibers in a thermoset matrix.

6. The method recited in claim 2, wherein the fiber-reinforced strength member comprises reinforcing fibers in a metal matrix.

7. The method recited in any one of claims 1 to 6, wherein the strength member comprises a single composite strength element.

8. The method recited in any one of claims 1 to 6, wherein the strength member comprises a plurality of composite strength elements.

9. The method recited in any one of claims 1 to 8, wherein the first distributed sensing element extends along substantially the entire length of the overhead electrical cable.

10. The method recited in any one of claims 1 to 9, wherein the first distributed sensing element comprises a first optical fiber.

11. The method recited in claim 10, wherein the first optical fiber is attached to a surface of the strength member.

12. The method recited in claim 10, wherein the first optical fiber is embedded in the strength member.

13. The method recited in any one of claims 10 to 12, wherein the first optical fiber is a glass optical fiber.

14. The method recited in any one of claims 1 to 13, wherein the overhead electrical cable has a length of at least about 100 meters.

15. The method recited in claim 14, wherein the overhead electrical cable has a length of at least about 500 meters.

16. The method recited in any one of claims 1 to 15, wherein the first linear segment has a length of not greater than about 10 meters.

17. The method recited in any one of claims 1 to 16, wherein the first distributed condition data comprises a first cable temperature data and wherein the first distributed condition value is a temperature value.

18. The method recited in claim 17, wherein the first non-distributed sensor comprises a thermocouple.

19. The method recited in any one of claim 17 or 18, further comprising the step of applying heat to a portion of the first overhead electrical cable that includes the first non-distributed sensor during the steps of obtaining the first distributed condition data and the first non-distributed condition data from the portion of the first overhead electrical cable.

20. The method recited in any one of claims 17 to 19, wherein the step of adjusting the interrogation device is performed when the difference between the first distributed condition value and the first non-distributed condition value is greater than a predetermined acceptable deviation value.

20. The method recited in claim 20, wherein the predetermined acceptance deviation value is not greater than about 10° C. absolute.

22. The method recited in any one of claims 1 to 16, wherein the first distributed condition data comprises first cable strain data and wherein the first distributed condition value is a strain value.

23. The method recited in claim 22, wherein at least the first non-distributed sensor comprises a strain gauge.

24. The method recited in claim 23, wherein the strain gauge is operatively affixed to the strength member.

25. The method recited in claim 22, wherein at least the first non-distributed sensor comprises a Fiber Bragg Grating (“FBG”).

26. The method recited in any one of claims 23 to 25, wherein:
the overhead electrical line comprises a dead-end assembly securing the first overhead electrical cable to a support tower; and
wherein the first non-distributed sensor is disposed within the dead end assembly.

27. The method recited in claim 22, wherein the first non-distributed sensor comprises a load cell affixed to the first overhead electrical cable.

28. The method recited in any one of claims 22 to 27, wherein the step of adjusting the interrogation device is performed when the difference between the first distributed condition value and the first non-distributed condition value is greater than a predetermined acceptable deviation value.

29. The method recited in claim 28, wherein the predetermined acceptance deviation value is a strain value of not greater than about 0.001% absolute.

30. The method recited in any one of claims 10 to 29, wherein the interrogation device comprises an OTDR device that is operatively connected to the first optical fiber.

31. The method recited in claim 30, wherein the OTDR device is a BOTDR device.

32. The method recited in any one of claim 30 or 31, wherein the step of adjusting the interrogation device comprises changing at least a first calibration coefficient of the OTDR device.

33. The method recited in any one of claims 1 to 32, wherein at least the first non-distributed sensor is operatively attached to the overhead electrical cable to obtain the first non-distributed condition data directly from the electrical cable.

34. The method recited in any one of claims 1 to 33, wherein the first non-distributed sensor is located within the first linear segment.

35. The method recited in any one of claims 1 to 34, further comprising the step of:
obtaining second non-distributed condition data from a second non-distributed sensor that is located proximate the first linear segment of the first distributed sensing element, the second non-distributed condition data comprising data selected from the group consisting of second non-distributed cable temperature data and second non-distributed strain data.

36. The method recited in claim 35, wherein the non-distributed condition value is obtained from the first non-distributed condition data and the second non-distributed condition data.

37. The method recited in any one of claims 1 to 36, further comprising the step of:
obtaining third non-distributed condition data from a third non-distributed sensor, the third non-distributed condition data comprising data selected from the group consisting of third non-distributed cable temperature data and third non-distributed strain data.

38. A system for the operation of an overhead electrical line, comprising:
an overhead electrical line that is operatively strung onto support towers, the overhead electrical line comprising a first overhead electrical cable comprising a strength member and an electrical conductor surrounding the strength member:
a first distributed sensing element that extends along a length of the first overhead electrical cable, the first distributed sensing element comprising an optical fiber;
an interrogation device operatively attached to the optical fiber; and
at least a first non-distributed sensor that is located proximate the first overhead electrical cable,
wherein the first non-distributed sensor is selected from the group consisting of a temperature sensor and a strain sensor, and
wherein the first non-distributed sensor is configured to measure at least one of a temperature value or a strain value of the overhead electrical cable.

39. The system recited in claim 38, wherein the strength member is a fiber-reinforced composite strength member.

40. The system recited in claim 39, wherein the fiber-reinforced strength member comprises reinforcing fibers in a polymer matrix.

41. The system recited in claim 40, wherein the fiber-reinforced strength member comprises reinforcing fibers in a thermoplastic matrix.

42. The system recited in claim 40, wherein the fiber-reinforced strength member comprises reinforcing fibers in a thermoset matrix.

43. The system recited in claim 39, wherein the fiber-reinforced strength member comprises reinforcing fibers in a metal matrix.

44. The system recited in any one of claims 38 to 43, wherein the strength member comprises a single composite strength element.

45. The system recited in any one of claims 38 to 43, wherein the strength member comprises a plurality of composite strength elements.

46. The system recited in any one of claims 38 to 45, wherein the first distributed sensing element extends along substantially the entire length of the overhead electrical cable.

47. The system recited in any one of claims 38 to 46, wherein the first distributed sensing element comprises a first optical fiber.

48. The system recited in claim 47, wherein the first optical fiber is attached to a surface of the strength member.

49. The system recited in claim 47, wherein the first optical fiber is embedded in the strength member.

50. The system recited in any one of claims 47 to 49, wherein the first optical fiber is a glass optical fiber.

51. The system recited in any one of claims 38 to 50, wherein the overhead electrical cable has a length of at least about 100 meters.

52. The system recited in claim 51, wherein the overhead electrical cable has a length of at least about 500 meters.

53. The system recited in any one of claims 38 to 52, wherein the first non-distributed sensor comprises a thermocouple.

54. The system recited in any one of claims 38 to 52, wherein the first non-distributed sensor comprises an infrared camera.

55. The system recited in any one of claims 38 to 52, wherein the first non-distributed sensor comprises a strain gauge that is operatively coupled to the strength member.

56. The system recited in claim 55, wherein the overhead electrical line comprises a dead-end assembly securing the first overhead electrical cable to a support tower, and wherein the strain gauge is disposed within the dead end assembly.

57. The system recited in any one of claims 38 to 56, wherein the interrogation device comprises a OTDR device that is operatively attached to the optical fiber.
